(19) United States
(12) Patent Application Publication
(10) Pub. No.: US 2002/0167771 A1
(43) Pub. Date: Nov. 14, 2002

(54) Countercurrent prevention circuit

(75) Inventor: Hiroshi Kamiya, Osaka (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/136,319

(22) Filed: May 2, 2002

(30) Foreign Application Priority Data
May 10, 2001 (JP) 139470/2001

(51) Int. Cl. H02H 3/18

(52) U.S. Cl. 361/84

(57) ABSTRACT

A countercurrent prevention circuit of the present invention includes: a first circuit which has a first terminal connected to a battery and a second terminal connected to a device, and connects or disconnects between the first and the second terminals; and a second circuit which determines which of the potentials of the first and the second terminals is higher. The first circuit disconnects between the first and second terminals when the second circuit determines that the potential of the second terminal is higher than that of the first terminal. The first circuit connects between the first and the second terminals when the second circuit determines that the potential of the first terminal is higher than that of the second terminal.

### BACKGROUND OF THE INVENTION

The present invention relates to a countercurrent prevention circuit, and more particularly to a countercurrent prevention circuit, to be connected between a primary battery, such as a lithium battery, and a device to be supplied with a current from this primary battery.

Lithium batteries of 3-volt type or other types are used in an extensive range of applications including household electrical appliances, desktop calculators and backup power sources by virtue of their compact size, light weight, high energy density and low self-discharging characteristics. It is desirable for a lithium battery designed as a primary battery to be free from the flow of a countercurrent from a load (device) to the battery. For this reason, where a lithium battery is used as a backup power source or the like, a circuit for preventing a countercurrent may be inserted according to the prior art between the battery and a device to be supplied with a current from it when the battery is backing up.

In one of such countercurrent prevention circuits according to the prior art, as illustrated in FIG. 5, a diode 10 is inserted between the positive pole of a battery and the power input terminal of a device. An anode of the diode 10 is connected to a battery positive pole terminal 1 and a cathode of the diode 10 is connected to a device terminal 2. In this circuit, even if the potential of the device terminal 2 (the potential of a power supply circuit of the device) surpasses the potential of the battery positive pole terminal 1 (the battery's voltage), the diode 10 will serve as a barrier to prevent a countercurrent from flowing into the battery. However, in this conventional circuit wherein a diode blocks a countercurrent, a voltage drop about 0.7 volts due to the forward voltage VF of the diode arises when a current is supplied to the load (device). As a result, where a 3-volt lithium battery is used for instance, the voltage supplied to the power supply circuit of the device drops to 2.3 volts. Accordingly, the 3.0 volts actually needed by the power supply circuit of the device cannot be supplied, and the circuit may not be able to work normally.

### SUMMARY OF THE INVENTION

An object of the present invention, therefore, is to provide a countercurrent prevention circuit which prevents a countercurrent from flowing back to the battery even if the potential of the device surpasses the battery's voltage and at the same time reduces the voltage drop due to this circuit to supply a voltage actually required to the power supply unit of the device.

According to one aspect of the present invention, a countercurrent prevention circuit is provided which includes: a first circuit which has a first terminal connected to a battery and a second terminal connected to a device, and connects or disconnects between the first and the second terminals; and a second circuit which determines which of the potentials of the first and the second terminals is higher; wherein the first circuit disconnects between the first and the second terminals when the second circuit determines that the potential of the second terminal is higher than that of the first terminal; and wherein the first circuit connects between the first and the second terminals when the second circuit determines that the potential of the first terminal is higher than that of the second terminal.

According to another aspect of the present invention, a countercurrent prevention circuit, which is connected between a battery and a device, which receives a current from said battery, is provided which includes: a field effect transistor of which either the source or the drain is connected to an output of said battery, and the other is connected to an input of said device; and a control element which monitors potentials of said input of said device and said output of said battery, and supplies, when the potential of said input of the device rises above the potential of said output of said battery, the gate of said field effect transistor with a first potential which cuts off said field effect transistor.

### BRIEF DESCRIPTION OF THE DRAWINGS

Other features and advantages of the present invention will be made more apparent by the following detailed description and the accompanying drawings, wherein:

FIG. 1 is a circuit of a first embodiment of the present invention;

FIG. 2 is a circuit of a second embodiment of the present invention;

FIG. 3 is a circuit of a third embodiment of the present invention;

FIG. 4 is a circuit of a fourth embodiment of the present invention; and

FIG. 5 is a conventional circuit.

In the drawings, the same reference numerals represent respectively the same structural elements.

### DETAILED DESCRIPTION OF THE PREFERRED EMBODIMENTS

A first embodiment of the present invention will be described in detail below.

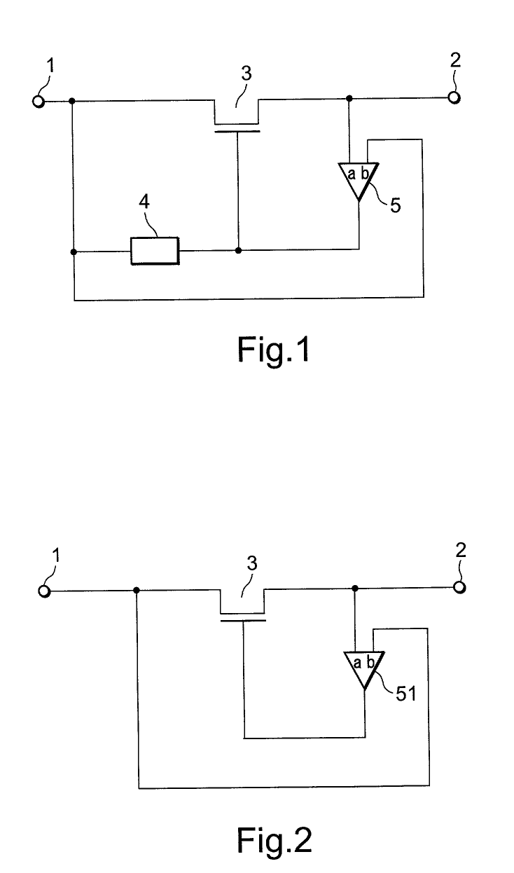

Referring to FIG. 1, a countercurrent prevention circuit includes an n-channel type MOSFET 3, a resistance element 4 and a potential comparator 5. The n-channel type MOSFET 3 has a first terminall connected to a battery and a second terminal 2 connected to a device, and connects or disconnects between the first and second terminals. Specifically, the n-channel type MOSFET 3 has a drain connected to a battery positive pole terminal 1, a source connected to a device terminal 2, and a gate connected to the drain via the resistance element 4. The battery positive pole terminal 1 is connected to the battery. The device terminal 2 is connected to the device. To monitor the source potential of the device, the source of the MOSFET 3 is connected to a first input terminal a of the potential comparator 5, and the drain of the MOSFET 3 is connected to a second input terminal b of the potential comparator 5. An output terminal of the potential comparator 5 is connected to the connection point between the gate of the MOSFET 3 and the resistance element 4. The comparator 5 determines which of the potentials of the battery positive pole terminal 1 and the device terminal 2 is higher. More specifically, in the potential comparator 5, when the second input terminal b has a higher potential than the first input terminal a, the output terminal takes on a high impedance or, conversely, when the first input terminal a has a higher potential than the second input terminal b, it supplies a low-level voltage. The MOSFET 3 disconnects between the battery positive pole terminal 1 and the device terminal 2 when the comparator 5 determines that the potential of the device terminal 2 is higher than that of the battery positive pole terminal 1. The MOSFET 3 connects between the battery positive pole terminal 1 and the device terminal 2 when the comparator 5 determines that the potential of the battery positive pole terminal 1 is higher than that of the device terminal 2. The resistance element 4 may be formed of a polysilicon resistor, a diffused resistor or the like. The resistance element 4 may as well be a field effect transistor, such as a MOSFET.

Now, the operation of this embodiment will be described.

It is supposed that the positive pole of a 3.0-volt lithium battery is connected to the battery positive pole terminal 1 and the device terminal 2 is connected to the power supply circuit of the device. If the potential of the power supply circuit of the device falls to 2.9 volts and the battery's voltage remains at 3.0 volts, the output terminal of the potential comparator 5 is in a high impedance state. As 3.0 volts is supplied to the gate of the MOSFET 3 via the resistance element 4, the MOSFET 3 is in a conduction state, and a current is supplied to the device via the MOSFET 3. Supposing here that the amperage of the current supply from the battery is 10 milliamperes and the resistance of the MOSFET 3 is 2.0 ohms, the voltage drop at the MOSFET 3 will be 10 milliamperes×2.0 ohms=0.02 V. Therefore, the input section of the power supply circuit of the device is supplied with a voltage of 3.00 volts−0.02 volts=2.98 volts, and the normal operation of the device circuit is thereby ensured. Then, as the first input terminal a of the potential comparator 5 is also supplied with 2.98 V and the potential comparator 5 maintains the high impedance state, the MOSFET 3 remains in the conduction state.

Next to suppose that the potential on the device side to be inputted to the first input terminal b of the potential comparator 5 rises above the battery's voltage, for instance 3.1 V, the potential inputted to the first input terminal a of the potential comparator 5 will become higher than the potential inputted to the second input terminal b, with the result that the potential comparator 5 supplies a low level to cut off the MOSFET 3. This prevents a countercurrent from flowing into the positive pole side 1 of the 3-volt lithium battery from the device's power input terminal 2.

Next, a second embodiment of the present invention will be described in detail. This second embodiment of the invention differs from the first embodiment in that it has no resistance element for providing a bias to the gate of the MOSFET 3 and only an output terminal of a potential comparator 51 is connected to the gate of the MOSFET 3. It is the same as the first embodiment in all other respects of configuration.

Referring to FIG. 2, a countercurrent prevention circuit embodying the invention in this second mode includes a MOSFET 3 and a potential comparator 51. A first input terminal a of the potential comparator 51 is connected to the source terminal of the MOSFET 3. A second input terminal b of the potential comparator 51 is connected to the drain terminal of the MOSFET 3. An output terminal of the potential comparator 51 is connected to the gate of the MOSFET 3. When the potential on the second input terminal b of the potential comparator 51 is higher than that of the first input terminal a, the output terminal of the comparator 51 supplies a voltage of a high level, or, conversely, when the potential on the first input terminal a is higher than that of the second input terminal b, the output terminal of the comparator 51 supplies a voltage of a low level.

If the battery's voltage of 3.0 volts is inputted to the second input terminal b of the potential comparator 51 and the voltage at the device terminal 2 falls below 3 V, for instance to 2.9 V, a high level will be supplied from the output terminal of the potential comparator 51. The MOSFET 3 takes on a conduction state, and the current flows from the battery side 1 to the device side 2. On the other hand, if the voltage of the device terminal 2 rises above 3 V, for instance to 3.1 V, a low level will be supplied from the output terminal of the potential comparator 51. As a result, the MOSFET 3 is cut off, and a countercurrent from the device side 2 to the battery side 1 is blocked.

Next, a third embodiment of the present invention will be described in detail. The third embodiment of the invention differs from the first embodiment in that an n-channel type MOSFET 6 having a similar function to an n-channel type MOSFET 3, serving as the current path from the battery to the device, is connected in parallel to the MOSFET 3 and that a resistance element 42 is connected between an output terminal of a potential comparator 52 and the gates of the MOSFETs. It is the same as the first embodiment in all other respects of configuration.

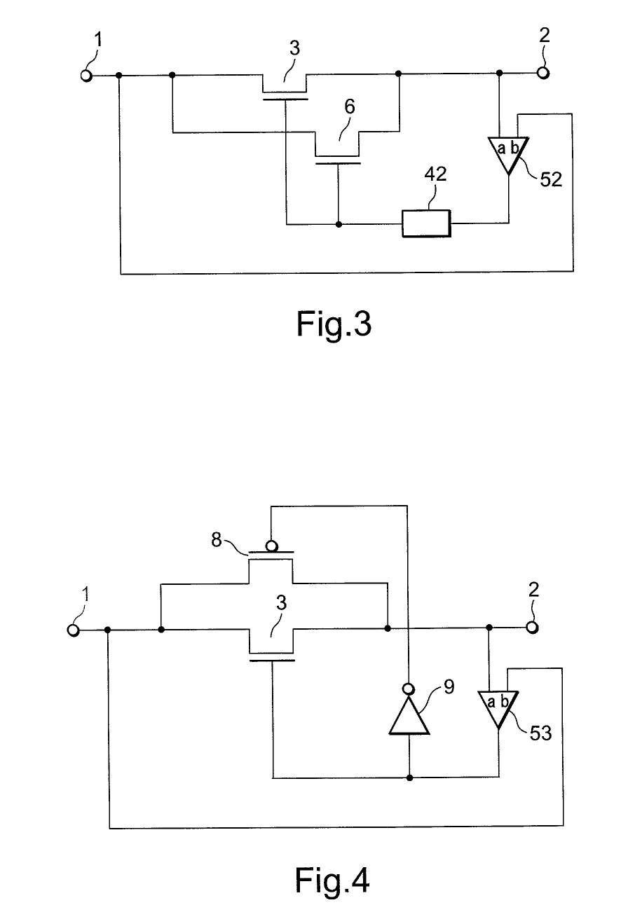

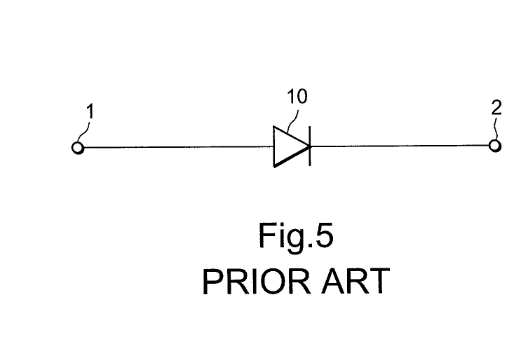

Referring to FIG. 3, a countercurrent prevention circuit embodying the invention in this third mode includes the n-channel type MOSFETs 3 and 6, the resistance element 42 and the potential comparator 52. The MOSFET 3 has a drain connected to the battery positive pole terminal 1, a source connected to the device terminal 2, and a gate connected to the resistance element 42. The MOSFET 6 has a drain connected to the battery positive pole terminal 1, a source connected to the device terminal 2, and a gate connected to the resistance element 42. The MOSFETs 3 and 6 are connected in parallel. The first input terminal a of the potential comparator 52 is connected to the source terminal of the MOSFET 3 and the source terminal of the MOSFET 6. A second input terminal b of the potential comparator 52 is connected to the drain terminal of the MOSFET 3 and the drain terminal of the MOSFET 6. An output terminal of the potential comparator 51 is connected to the gate terminal of the MOSFET 3 and the gate terminal of the MOSFET 6 via the resistance element 42.

Supposing that in the first through third embodiments all the MOSFETs in FIG. 1 through FIG. 3 are fabricated in the same size, this third embodiment can approximately double the current capacity and halve the resistance as compared with the first and second embodiments. The number of MOSFETs to be connected in parallel in this embodiment is not limited to two, but may be three or even more.

Next, a fourth embodiment of the present invention will be described in detail. The fourth embodiment of the invention differs from the second embodiment in that a p-channel type MOSFET 8 is connected in addition and in parallel (anti-parallel) to an n-channel type MOSFET 3 inserted on the current path from the battery to the device. It is the same as the second embodiment in all other respects of configuration.

Referring to FIG. 4, a countercurrent prevention circuit embodying the invention in the fourth mode includes the n-channel type MOSFET 3, the p-channel type MOSFET 8, an inverter 9 and a potential comparator 53. The p-channel type MOSFET 8 comprises a source connected to the battery positive pole terminal 1, a drain connected to the device terminal 2, and a gate connected to the inverter 9. An output terminal of the potential comparator 53 is connected to the gate of the n-channel type MOSFET 3 and via the inverter 9 to the p-channel type MOSFET 8. A first input terminal a of the potential comparator 53 is connected to the source terminal of the MOSFET 3 and the drain terminal of the MOSFET 8. A second input terminal b of the potential comparator 53 is connected to the drain terminal of the MOSFET 3 and the source terminal of the MOSFET 8. The inverter 9 inverts the out put of the potential comparator 53, and inputs the inverted output to the gate terminal of the MOSFET 8.

The circuit embodying the invention in this mode operates similarly to the second embodiment, and can provide the same advantages as the second embodiment does.

Although the present invention has been described so far with reference to the preferred embodiments thereof, the invention is not limited to these embodiments, but can be modified as appropriate without deviating from the essentials thereof. For instance, a p-channel type MOSFET can be used in place of the n-channel type MOSFET 3. Also, instead of a MOSFET, a non-MOS type field effect transistor can be used. Further, field effect transistors to be used in the invention are not limited to enhancement type transistors but depletion type ones may be used as well. However, where depletion type transistors are to be used, it is necessary for the potential comparators 5, 51, 52 and 53 to be able to supply positive and negative voltages. The countercurrent prevention circuit according to the invention can also be applied to device circuits of which the power source side has a negative potential and the grounding side has a positive potential.

As hitherto described, according to the present invention, a field effect transistor for preventing a countercurrent is inserted on the power input path between the battery and the device. As a result, not only can a countercurrent be prevented, but also a voltage fall attributable to a countercurrent prevention circuit can be sufficiently restrained not to affect the operation of the device. Therefore, according to the invention, the battery can be securely protected from damage by a countercurrent and, where the device side loses its power source and thereby necessitates supply of a current from the battery side, it is made possible to supply the voltage needed by the device circuit from the battery, and thereby to enhance the operational reliability of the device.

While this invention has been described with reference to the preferred embodiments cited above, it will now be possible for those skilled in the art to put this invention into practice in various other manners.

What is claimed is:

1. A countercurrent prevention circuit comprising:
a first circuit which has a first terminal connected to a battery and a second terminal connected to a device, and connects or disconnects between said first and said second terminals; and
a second circuit which determines which of the potentials of said first and said second terminals is higher;
wherein said first circuit disconnects between said first and said second terminals when said second circuit determines that the potential of said second terminal is higher than that of said first terminal; and
wherein said first circuit connects between said first and said second terminals when said second circuit determines that the potential of said first terminal is higher than that of said second terminal.

2. The countercurrent prevention circuit as claimed in claim 1, further comprising a resistance element;
wherein said first circuit has an input terminal; and
wherein said resistance element is connected between said input terminal and said first terminal.

3. The countercurrent prevention circuit as claimed in claim 1, wherein said first circuit includes an input terminal;
wherein said second circuit includes an output terminal; and
wherein said output terminal is coupled to said input terminal.

4. The countercurrent prevention circuit as claimed in claim 1, further comprising a third circuit which is connected in parallel to said first circuit, has a first terminal connected to said battery and a second terminal connected to said device, and connects or disconnects between said first and said second terminals.

5. The countercurrent prevention circuit as claimed in claim 1, further comprising a fourth circuit which is connected in parallel to said first circuit, has reverse polarity of said first circuit, has a first terminal connected to said battery and a second terminal connected to said device, and connects or disconnects between said first and said second terminals.

6. The countercurrent prevention circuit as claimed in claim 5, further comprising an inverter;
wherein said fourth circuit includes an input terminal;
wherein said second circuit includes an output terminal; and
wherein said inverter is connected between said input terminal and said output terminal.

7. The countercurrent prevention circuit as claimed in claim 1, wherein said first circuit includes a transistor.

8. The countercurrent prevention circuit as claimed in claim 1, wherein said second circuit includes a comparator.

9. A countercurrent prevention circuit connected between a battery and a device, which receives a current from said battery, comprising:
a field effect transistor of which either the source or the drain is connected to an output of said battery, and the other is connected to an input of said device; and
a control element which monitors potentials of said input of said device and said output of said battery, and supplies, when the potential of said input of the device rises above the potential of said output of said battery, the gate of said field effect transistor with a first potential which cuts off said field effect transistor.

10. The countercurrent prevention circuit as claimed in claim 1, wherein said control element includes a comparator which has an output terminal connected to the gate of said field effect transistor, a first input terminal receiving the source potential of said device, and a second input terminal receiving the battery potential.

11. The countercurrent prevention circuit as claimed in claim 9, further comprising a resistance element which is connected between said output of said battery and the gate of said field effect transistor.

12. The countercurrent prevention circuit as claimed in claim 11, wherein said resistance element is selected from the group consisting of a polysilicon resistor, a diffused resistor and a field effect transistor.

13. The countercurrent prevention circuit as claimed in claim 9, further comprising a resistance element which is connected between an output of said control element and the gate of said field effect transistor.

14. The countercurrent prevention circuit as claimed in claim 13, wherein said resistance element is selected from the group consisting of a polysilicon resistor, a diffused resistor and a field effect transistor.

15. The countercurrent prevention circuit as claimed in claim 9, further comprising at leas t one field effect transistor which prevents a countercurrent; and
wherein said transistors are connected in parallel between said battery and said device.

16. The countercurrent prevention circuit as claimed in claim 9, wherein said field effect transistor is a p-channel type field effect transistor; and
said circuit further comprises an n-channel type field effect transistor which prevents a countercurrent and is connected in anti-parallel with said p-channel type field effect transistor between said battery and said device.
